(19) United States
(12) Patent Application Publication
(10) Pub. No.: US 2014/0063531 A1
(43) Pub. Date: Mar. 6, 2014

(54) CONFIGURING AN IMAGING OR PRINTING DEVICE BACKGROUND

(71) Applicants: Matthew Lee Deter, Rocklin, CA (US); John Borz, Fair Oaks, CA (US); Douglas T. Albright, Rocklin, CA (US); Shivaun Albright, Rocklin, CA (US); Daryl Wong, Sacramento, CA (US)

(72) Inventors: Matthew Lee Deter, Rocklin, CA (US); John Borz, Fair Oaks, CA (US); Douglas T. Albright, Rocklin, CA (US); Shivaun Albright, Rocklin, CA (US); Daryl Wong, Sacramento, CA (US)

(21) Appl. No.: 13/598,229

(22) Filed: Aug. 29, 2012

(51) Int. Cl. G06F 3/12

(52) U.S. Cl. CPC G06F 3/1297
USPC 358/1.14; 358/1.15

(57) ABSTRACT

An imaging or printing device has a storage medium storing a hostname of a configuration server and sends a DNS request for the hostname to a DNS server. After receiving an IP address corresponding to the configuration server from the DNS server, the printing or imaging device uses the IP address to contact the configuration server and receives configuration settings from the configuration server.

Printing and imaging devices as referred to in this disclosure include mono-function and multi-function office machines having printing and/or imaging functionality. For example laser, dot matrix, inkjet printers etc, scanners and MFP (Multi Function Printer) devices which are capable of both printing and scanning. Many such products are connectable to an office network and may communicate using TCP/IP, email or other protocols.

Printing and imaging devices may have a large number of configuration settings that enable them to operate in the enterprise network and which may for example specify the way in which the device handles print and imaging jobs, the way in which the device communicates with other devices, security and access control.

Security is a serious issue and can be particularly important for printing and imaging devices as they may be used to print, scan and/or distribute confidential documents. If an unauthorized third party is able to gain access to the device or the contents of its memory, then this may result in theft of confidential information. Further, if adequate security measures are not in place an attacker may be able to use the device to gain access to the enterprise network and other privileged resources.

### BRIEF DESCRIPTION OF THE DRAWINGS

Examples of the invention will now be described, by way of non-limiting example only, with reference to the accompanying drawings, in which:

FIG. 1 shows an example of an enterprise network having a printing or imaging device, a DNS server and a configuration server;

FIG. 2 shows an example of a method of configuring the printing or imaging device;

FIG. 3 is a schematic diagram showing an example of a printing or imaging device; and

FIG. 4 is a schematic diagram showing an example of a configuration server.

### DETAILED DESCRIPTION

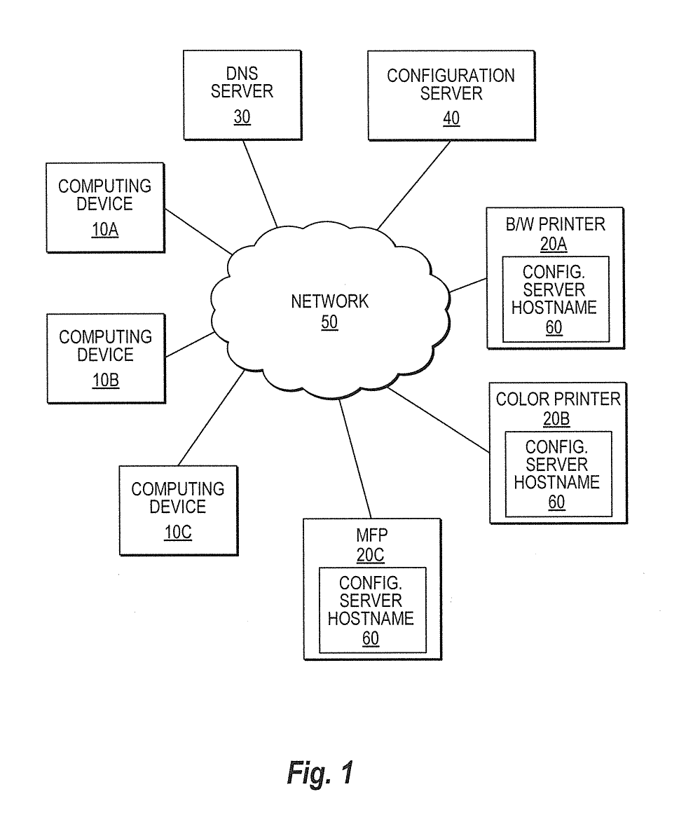

FIG. 1 shows an enterprise network having a plurality of computing devices 10A-10C, a plurality of printing or imaging devices 20A-20C, a Domain Name Server (DNS) 30 and a configuration server 40. The computing devices may for example be desk top computers, notebook computers or mobile computing devices etc. The printing or imaging devices may be any devices with a printing and/or scanning function, e.g. an ink jet printer, a black and white laser printer, a color printer, a stand-alone scanner or a MFP device etc. The DNS Server has a list of domain names and corresponding IP addresses and responds to requests from devices on the network for IP addresses corresponding to particular hostnames. The configuration server stores one or more configuration policies for printing and imaging devices, which policies specify configuration settings for printing and imaging devices on the network.

The network 50 is shown schematically in FIG. 1. It may comprise a plurality of communication links, hubs, switches, routers, access points etc. connecting the various devices. The network 50 enables the various devices to communicate with each other and may have a large number of nodes. The network may for example be a local area network, or a plurality of linked IP-subnets or a virtual private network (VPN) spanning several sites. The network may comprise wired and/or wireless connections and use networking protocols such as, but not limited to, Ethernet, token ring, TCP/IP, IEEE 802.11 etc.

The enterprise network is a private network in that communications on the network cannot be seen by entities outside of the network. The enterprise network typically belongs to a single company and all the devices on the network belong to or are authorized by the company to connect to the network and in many cases will be configured by the company's IT department.

Each imaging and printing device is configured to store a hostname 60 of a configuration server. The hostname may for example be hardwired into the device at the factory, or alternatively may be set by the user (e.g. a company's IT department) after the device has been purchased. As the company owns the DNS server 30 they are able to set its contents and configure the DNS server to point the aforementioned hostname to the IP address of the configuration server 40. Thus when the imaging or printing device is first connected to the network it can simply contact the DNS server to request the IP address of the configuration server and then connect to the configuration server by sending a unicast message to the configuration server's IP address.

This method minimizes or avoids tedious manual configuration of printing and imaging devices, as the configuration server can perform the configuration automatically after it is notified of the device's presence on the network. The method is practical even on large networks, or IPv6 networks with a large number of possible addresses, as the configuration server does not need to scan for the presence of new devices and the printing or imaging device does not need to send a broadcast to locate the configuration server. Rather, the device can automatically contact the configuration server directly to announce its presence by sending a unicast to the server's IP address. Furthermore, as the configuration server is contacted by a unicast message to its IP address, the method can be used even when the configuration server is on a different physical LAN or VLAN to the imaging or printing device. Thus it is possible to store imaging and printing device configuration policies centrally on a large corporate network spanning several LANs or VLANs.

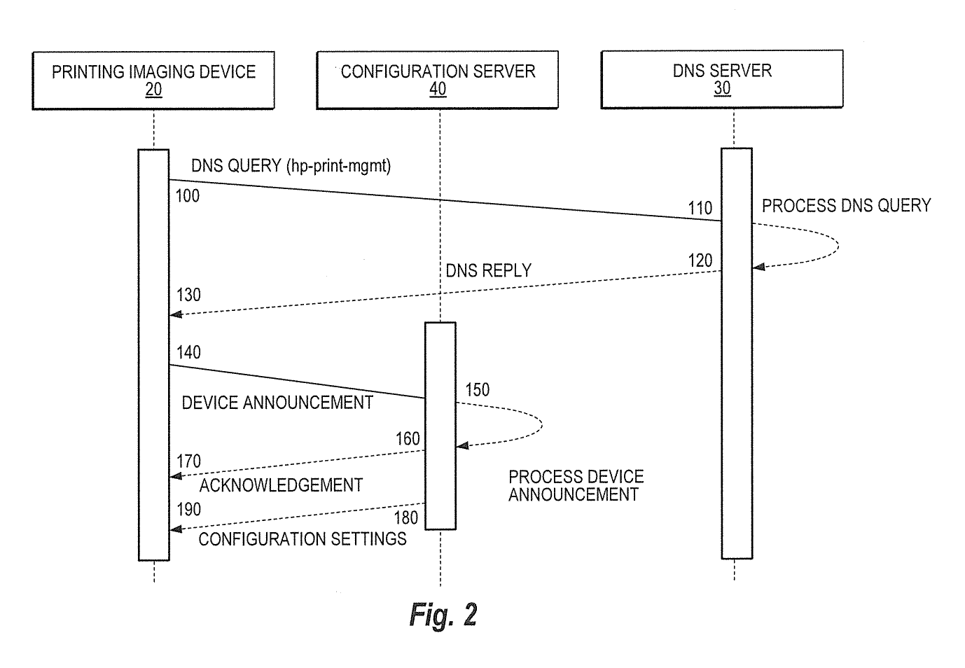

An example of the method is described in more detail below with reference to FIG. 2. At 100 the printing or imaging device 20 sends a DNS query for a predetermined hostname stored in its memory to the DNS server 30. In this example the hostname is “hp-print-mgmt”. The hostname may conveniently be hardwired into the device by the manufacturer. An enterprise using printing or imaging devices from that manufacturer then simply needs to configure the DNS server(s) in their enterprise network to store an entry pointing the predetermined hostname to the IP address of the configuration server 40. The printing or imaging device can then be configured according the enterprise's desired configuration and policies.

At 110 the DNS server 30 receives the DNS query and processes it. At 120 the DNS server sends a response (DNS reply) to the device 20 listing an IP address for a configuration server. At 130 the device receives the DNS reply providing the IP address of the configuration server.

At 140 the printing or imaging device sends a unicast message to the IP address of the configuration server announcing its presence on the network. The message may be in accordance with a protocol and may for example comprise a header and a payload indicating the printing or imaging device name, MAC address, IP address, device serial number, network serial number, a password hash etc.

While in the above example there is only one configuration server, it is possible for an enterprise network to have more than one configuration server. In that case the DNS server may be configured to return a list of IP addresses each corresponding to a respective configuration server. The printing or imaging device may then store these IP addresses in memory and select one of the IP addresses to contact.

Returning to FIG. 2, at 150 the configuration server receives and processes the announcement from the printing or imaging device. At 160 the configuration server sends an acknowledgement to the printing or imaging device acknowledging that the announcement has been received. At 170 the acknowledgement is received by the printing and imaging device; if the printing or imaging device does not receive an acknowledgement it assumes that the announcement has not been received and sends it again. At 180, after sending the acknowledgement, the configuration server sends configuration settings to the printing or imaging device. At 190 the printing or imaging device receives the configuration settings and implements the settings on the device.

The configuration settings may be any settings relating to security, access control, communication between the printing or imaging device with computing devices and servers on the network, storage of data and printing or imaging operations etc. Examples include settings specifying methods by which a print job or scanned image may be delivered to a user; the identity of an email server with which the device may communicate, a policy for retention or encryption of data relating to imaging or print jobs; a policy for deletion of data relating to imaging or print jobs after completion; and security credentials required by a user to perform a particular printer or scanner operation.

More detailed examples of communication between the printing or imaging device and configuration server will now be discussed. The printing or imaging device may be configured to send a unicast message, announcing its presence to the configuration server, whenever it is switched on, re-set, newly connected to the network or changes its IP address. As mentioned above, the printing or imaging device finds the IP address of the configuration server through a DNS request for the configuration server's hostname to the DNS server. However, as some companies may not wish to configure the DNS server on their network, the printing or imaging device may be provided with an override function whereby the IP address of the configuration server may be manually configured (e.g. by an administrator over a web interface). If the override is set then the printing or imaging device sends a unicast to the manually configured IP address first and only contacts the DNS server with a DNS request if it cannot establish a satisfactory connection at the manually configured IP address.

The configuration server may respond to the announcement from the printing or imaging device by requesting details of the printing or imaging device's configuration settings. Alternatively the announcement itself may contain this information. In either case, when the configuration server receives the current settings of the printing or imaging device it checks them against a configuration policy suitable for that printing or imaging device. The configuration policy is set by the enterprise and comprises configuration settings as described above. The enterprise may for instance have one policy for all printing and imaging devices, or different policies for different types of device. If the configuration server detects any configurations not in accordance with the policy then the configuration server sends an instruction to the device to change its configuration settings accordingly (e.g. the configuration server sends the correct configuration settings to the device). The device then configures itself accordingly.

In an alternative implementation the configuration server may simply send the configuration policy to the device in response to the announcement and the device may check whether or not it is in compliance and make any necessary changes (or simply wipe all settings and replace them with those in the policy. Any suitable protocol may be used for communicating the device settings, for example SNMP, HTTP, proprietary data formats or a combination thereof.

Security of communication is a significant concern for some enterprises as if a non-authorized party is able to access or gain control of the printing or imaging device this may result in theft of confidential data. For example a rogue configuration server could set up the printing or imaging device to send all print or scan jobs to an email address owned by an attacker. Further, if a rogue device is able to connect to the configuration server then this may result in a breach of network security or an entry point for a hacker into the enterprise network. Therefore, according to one implementation, the printing or imaging device may set up a secure connection with the configuration server before data is exchanged between them. The secure connection may for example be a TLS connection or any other secure protocol.

At a first level of security the printing or imaging device may simply send a self-signed identity certificate to the configuration server. This enables the configuration server to check that it is communicating with the same device throughout the session and for encryption keys to be passed between the configuration server and device to ensure secure communication. However, as the certificate is self-signed it does not enable the configuration server to verify the identity of the printing and imaging device.

A second (higher) level of security requires the printing or imaging device to send a password to the configuration server. The configuration server can then check the password against a password it expects from that device (the password may be different for each device or may be the same for all devices). This requires a password to be set up on each device before it connects to the configuration server (e.g. as part of a manual configuration or automatically at a staging station by the IT department before the devices are distributed for general use in the enterprise). The password is also set up on the configuration server, so that it knows what password to expect from the device and can validate it. The password will usually be sent in hashed form (i.e. processed by a hash function) before it is sent to the configuration server.

A third (still higher) level of security requires the printing or imaging device to send an identity certificate signed by a trusted party to the configuration server. The configuration server then checks the signature by the trusted party to ensure that the printing or imaging device is genuine before proceeding with the secure communication (this ensures the identity of the printing or imaging device and that it is authorized to access the enterprise network and ensuing communication between the device and configuration server can be encrypted). This approach may be combined with the password approach described above.

The above describes security in terms of ensuring the identity of the printing or imaging device. However, it may also be desirable for the printing or imaging device to check the identity of the configuration server. Thus each of the above levels of security may be applied by the printing or imaging device to the configuration server (e.g. the printing or imaging device may require an anonymous identity certificate, password and/or an identity certificate signed by a trusted party from the configuration server). This helps to prevent an attacker using a rogue server to configure the printing or imaging device. A higher level of security is achieved if both the printing or imaging device and the configuration server require an identity certificate signed by a trusted party.

The trusted party mentioned above may be an entity within the enterprise owning the network (e.g. the IT department or an administrator in the company which owns the printing and imaging device and configuration server). Although it would in principle also be possible to use an external certifying authority. Typically the certificate will be placed on the printing or imaging device at a staging station by the IT department before the device is distributed for general use in the company. In this way the company can ensure that only devices approved by the appropriate person can have the required identity certificate signed by the trusted party.

The printing or imaging device may be capable of various different levels of security as described above. Further it may be configured (e.g. by a flag) to reject any communications below a specified minimum security level. For example the printing or imaging device may be configured to attempt to establish a secure session at the highest level of security and if that is not possible (e.g. if the configuration server does not have a valid identity certificate signed by a trusted party), then attempt to establish a session at the next level of security (e.g. requesting a password from the server), and if that fails then requiring a self-signed security certificate etc. until a lowest specified minimum standard of security is reached. If it is not possible to establish a session at the minimum specified level of security then the printing or imaging device rejects the configuration sever and halts the communication (i.e. does not accept instructions or configuration settings from the server), it may also generate an error message.

This provides a highly configurable solution which can be adapted to the enterprise's needs. Thus for example, the factory setting may be for the printing or imaging device to require only a self-signed certificate, but the IT department of the company may change the configuration at a staging station (e.g. through a special server or a web interface) to require a password or an identity certificate signed by a trusted authority as the minimum standard.

Likewise the configuration server may be configured to accept only printing or imaging devices which pass a certain specified level of security (e.g. self-signed certificate, password, certificate signed by a trusted authority or certificate signed by a trusted authority and a password). Typically the configuration server may be set up to attempt to establish a session at the highest level of security and if that is unsuccessful, then proceed to the next highest level etc. until the minimum specified level of security is reached. If a connection cannot be established at the minimum specified level of security then the configuration server rejects the imaging or printing device and does not send it configuration settings, it may also generate a security alert. In this way a rogue device may be prevented from fully connecting to the enterprise network, as the configuration settings provided by the configuration server may include security credentials necessary for network access.

The above approach allows a manufacturer to provide printing and imaging devices which may be automatically configured upon joining a network at a level of security which may be set by each enterprise according to its needs. For instance some enterprises may be content with a self-signed certificate, while other enterprises may require trusted certificates for communication between the printing and imaging device and the configuration server.

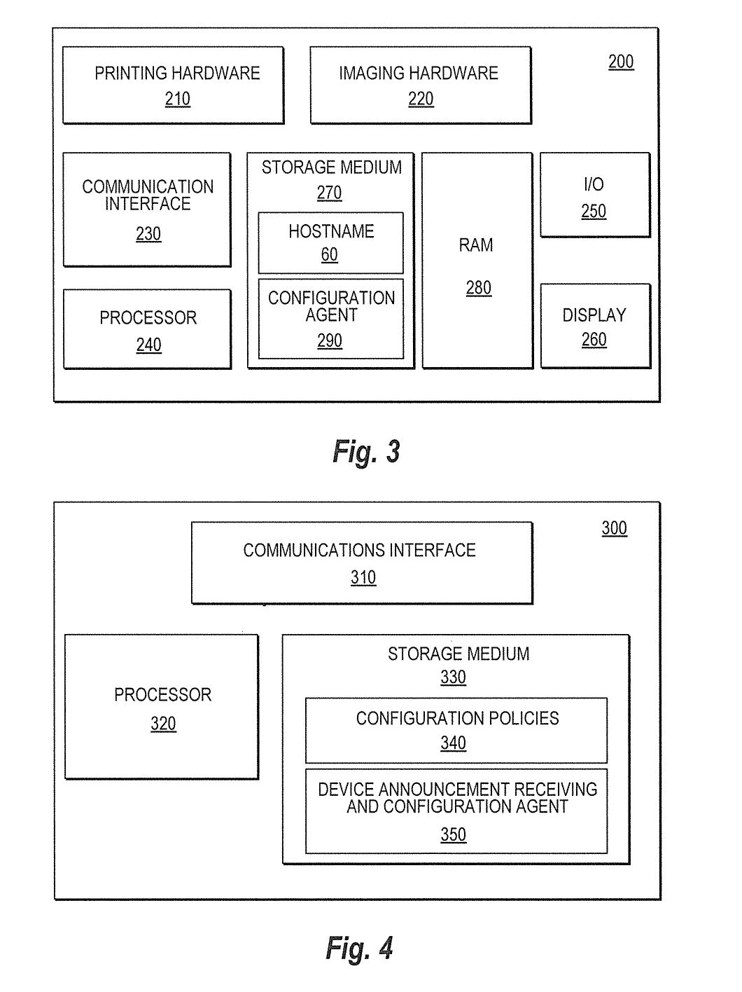

FIG. 3 is a schematic diagram showing an example structure for a printing or imaging device 200 in accordance with the present disclosure. In this example the device has both printing hardware 210 (e.g. a printing mechanism such as a print head, print cylinder, printing laser, and may also have a paper handling mechanism) and imaging hardware 220 (e.g. an imaging light source, detector and in some cases also a scanner bed or other mechanism for receiving paper or other objects to be scanned). In other cases the device may have only imaging hardware or only printing hardware.

The device also has a communications interface 230 for facilitating network communications e.g. over a wireless or wired link. The interface 230 may be capable of supporting a protocol such as Ethernet, TCP/IP or WLAN standard or other protocol depending on the capabilities of the device. The device also has a processor 240 for processing print or scan jobs and an I/O interface 250 for receiving user input—e.g via buttons, keys or a touch screen of the device. The device may also have a display 260 such as individual indicator LEDs or an LED screen. The device has a non-transitory storage medium 270, for example a ROM, flash memory or hard drive, which stores a predetermined hostname 60 (for instance “hp-print-mgmt”) which may be set by the manufacturer or the device owner. The storage medium 270 may also store firmware and software for facilitating printing, scanning and other operations of the device. The device also has a memory 280, such as a RAM or any other suitable storage medium, which may be used as a buffer for storing image and print jobs, and various other data such as an IP address of a configuration server and configuration settings.

The storage medium 270 further stores a ‘configuration agent’ 290 which is a program comprising machine readable instructions executable by the processor 240 to send a DNS request to a DNS server for the IP address associated with the predetermined hostname, send an announcement to the configuration server at the IP address, receive configuration settings from the configuration server and configure the device in accordance with the received configuration settings. Thus the agent comprises instructions executable by the processor to carry out the device side functions described in the present disclosure, for example in FIG. 2 and elsewhere.

FIG. 4 is a schematic diagram showing an example structure for a configuration server 300 in accordance with the present disclosure. The server comprises a communications interface 310 for facilitating communication over a network, a processor 320 and a non-transitory storage medium 330 such as a hard drive, optical disk, other magnetic, optical, or magneto-resistive storage medium etc. The storage medium 330 stores one or more policies 340 for printing or imaging devices (the policies comprise printing or imaging device configuration settings as described above) and a device announcement receiving and configuration agent 350 for receiving a unicast message from a printing or imaging device announcing presence of the device on the network, assessing the configuration of the device with reference to a policy 340 and sending configuration settings to the device. That is, the agent 350 comprises machine readable instructions executable by the processor 320 to carry out the configuration server side functions described herein, for example with reference to FIG. 2 and elsewhere.

Both the device side agent 280 and the agent 350 on the configuration server are able the carry out the various security measures described above and the printing or imaging device 200 and the configuration server 300 may be configured to require a minimum level of security, for example by specifying the minimum level in a flag or entry in a non-transitory storage medium or memory of the device or server.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of configuring an imaging or printing device, comprising:
the device sending, to a DNS server, a DNS request for a predefined hostname corresponding to a configuration server; said predefined hostname being stored in a non-transitory storage medium of the device;
the device receiving an IP address corresponding to the configuration server from the DNS server;
the device using the IP address to contact the configuration server and receiving printing or imaging device configuration settings from the configuration server; and
configuring the device in accordance with the received printing or imaging device configuration settings.

2. The method of claim 1 wherein the DNS server and the configuration server are on the same enterprise network as the printing or imaging device.

3. The method of claim 1 wherein the configuration settings comprise at least one of settings specifying the way in which a print job may be received by the device, settings specifying methods by which a print job or scanned image may be delivered to a user; the identity of an email server with which the device may communicate, a policy for retention or encryption of data relating to imaging or print jobs; a policy for deletion of data relating to imaging or print jobs after completion; and security credentials required by a user to perform a particular printer or scanner operation.

4. The method of claim 1 wherein the device sends its current configuration settings to the configuration server.

5. The method of claim 4 wherein the configuration server compares the current configuration settings with settings defined in a policy and instructs the device to change any settings not in compliance with the policy.

6. The method of claim 1 wherein the printing or imaging device sets up a secure connection with the configuration server before receiving printing or imaging configuration settings from said configuration server.

7. The method of claim 6 wherein the printing or imaging device sends a self-signed identity certificate to the configuration server.

8. The method of claim 6 wherein the printing or imaging device sends a pre-configured password to the configuration server and the configuration server validates the password with reference to a pre-configured password recorded on the configuration server for that device.

9. The method of claim 6 wherein the device requests an identity certificate signed by a trusted authority from the configuration server and checks the validity of the trusted certificate.

10. The method of claim 6 wherein the configuration server requests an identity certificate signed by a trusted authority from the device and checks the validity of the certificate.

11. The method of claim 10 wherein the trusted authority is the company owning the printing or imaging device and the configuration server.

12. A printing or imaging device comprising:
printing or imaging hardware;
a non-transitory storage medium storing a hostname of a configuration server;
a non-transitory storage medium storing configuration settings relating to printing or imaging; and
a configuration agent to send a request to a DNS server for the IP address corresponding to the hostname stored in the storage media, receive an IP address of the configuration server from the DNS server, send a unicast message announcing the device's presence on the enterprise network to the configuration server, receive configuration settings from the configuration server and implement said configuration settings on the device.

13. A printing or imaging device according to claim 12 wherein the agent is to provide current configuration settings of the printing or imaging device to the configuration server as part of the announcement or in response to a request from the configuration server.

14. A printing or imaging device according to claim 12 wherein the agent is to update the configuration settings in response to an instruction from the configuration server.

15. A printing or imaging device according to claim 12 wherein the agent is to require a minimum level of security from the configuration server and to reject the configuration server if a connection on said minimum level of security cannot be established.

16. A printing or imaging device according to claim 15 wherein the device is capable of setting up a secure connection at a plurality of different levels of security, wherein the device attempts each level of security starting with the highest and moving to less secure levels until a secure connection is successfully established with the configuration server or until it has failed to establish a secure connection at a minimum specified acceptable level, wherein said minimum specified acceptable level is configurable by an administrator.

17. The printing or imaging device of claim 12 wherein a storage medium of the device stores an identity certificate signed by an authority trusted by the enterprise owning the device and the configuration server.

18. A configuration server for configuring printing or imaging devices, the server comprising:
a processor; and
a non-transitory storage medium storing machine readable instructions and an imaging or printing configuration policy; the machine readable instructions being executable by the processor to, in response to receiving a unicast announcement from a printing or imaging device announcing the presence of the printing or imaging device to the server, send printing or imaging configuration settings to the device.

19. The configuration server of claim 18 wherein the instructions are to compare configuration settings of the device to said policy and send instructions to the device to change any settings not in accordance with said policy.

20. The configuration server of claim 18 wherein the server is capable of establishing connections at a plurality of different levels of security and the instructions are to establish a secure connection with the printing or imaging device and if a connection cannot be established at a minimum level of security then reject the printing or imaging device.
